(19) United States
(12) Patent Application Publication
(10) Pub. No.: US 2010/0266113 A1
(43) Pub. Date: Oct. 21, 2010

(54) TELEPHONE CALL MAINTENANCE WITH SINGLE PARTY FOR SUBSEQUENT RECONNECTION

(75) Inventor: John B. Hartley, North Fitzroy (AU)

Correspondence Address: HOFFMAN WARNICK LLC, 75 STATE ST, 14TH FLOOR, ALBANY, NY, 12207, US

(73) Assignee: INTERNATIONAL BUSINESS MACHINES CORPORATION, Armonk, NY (US)

(21) Appl. No.: 12/425,849

(22) Filed: Apr. 17, 2009

(51) Int. Cl. H04M 3/42

(52) U.S. Cl. 379/207.04

(57) ABSTRACT

Disclosed herein is a solution for managing telephone calls that allows a telephone switch to maintain a connection with one Party to a telephone call while allowing the connection between the switch and the other Party to be disconnected. When the parties wish to be reconnected, the switch re-establishes the connection between the switch and the other Party and reconnects the call.

### TECHNICAL FIELD

This disclosure relates generally to telephone call management, and more particularly to a solution for managing telephone calls which allows a Calling Party or Called Party to disconnect and be reconnected to a call.

### BACKGROUND ART

Often, when calling a customer service center or organization, a caller is put into a call queue to wait for the next available operator. The caller typically waits on hold until the call is put through to the operator. While on hold, a caller usually needs to keep the phone off the hook and listen until the call is put through. There are obvious downsides to this situation, including the waste of time for the caller, and the inability for the caller to do other things while on hold, or use the phone for other purposes. Even if a caller put the phone call on speakerphone, or uses a cordless phone, these systems are inconvenient for the caller and do not allow the caller to continue to use the phone while waiting in the queue.

Some organizations do provide an alternative option to waiting in the call queue. This alternative option is typically referred to as a “call me back” option. With this option, a voice response unit that answers the call asks if the caller would like to wait or whether they would prefer to be called back. If the caller asks to be called back, then it will typically either provide the option for the caller to key in a number or use the number that the incoming call was made from as the call back number. Some systems will also allow a caller to specify a preferred call back time. Organizations do not usually prefer this alternative option because it is inefficient from the organization's standpoint. The most efficient way for an organization to ensure that its operators are continuously answering calls is to keep the calls in queues. This way, there is no wasted time by the operators in juggling call backs at specific times.

Moreover, existing systems for managing phone calls as discussed above require a called party to install or have access to special software and technology.

### SUMMARY OF THE INVENTION

Aspects of the invention provide an improved solution for managing telephone calls. Specifically, a solution is disclosed that allows a telephone switch to maintain a connection with one Party to a telephone call while allowing the connection between the switch and the other Party to be disconnected. Subsequently, the switch re-establishes the connection between the switch and the other Party and reconnects the call.

A first aspect of the invention provides a method of managing telephone calls, the method comprising: receiving a first notification on a telephone switch from a first party on a first connected call between only the first party and a second party; and maintaining the first connected call from the telephone switch to the second party in response to receiving the first notification, without regard for the first party maintaining the connection between the first party and the telephone switch.

A second aspect of the invention provides a system for managing telephone calls, the system comprising: a telephone switch including: a component configured to receive a first notification from a first party on a first connected call between only the first party and a second party; and a component configured to maintain the first connected call from the telephone switch to the second party in response to receiving the first notification, without regard for the first party maintaining the connection between the first party and the telephone switch.

A third aspect of the invention provides a program product stored on a computer-readable medium, which when executed, enables a telephone switch to implement a method for managing telephone calls, the program product comprising: program code for receiving a first notification from a first party on a first connected call between only the first party and a second party; and program code for maintaining the first connected call between the telephone switch to the second party in response to receiving the first notification, without regard for the first party maintaining the connection between the first party and the telephone switch.

A fourth aspect of the invention provides a method of generating a system for managing telephone calls, the method comprising: providing a telephone switch operable to: receive a first notification from a first party on a first connected call between only the first party and a second party; and maintain the first connected call from the telephone switch to the second party in response to receiving the first notification, without regard for the first party maintaining the connection between the first party and the telephone switch.

A fifth aspect of the invention provides a method comprising: at least one of providing or receiving a copy of a computer program that is encoded in a set of data signals, wherein the computer program enables a computer system to implement a method of managing telephone calls, the method comprising: receiving a first notification on a telephone switch from a first party on a first connected call between only the first party and a second party; and maintaining the first connected call from the telephone switch to the second party in response to receiving the first notification, without regard for the first party maintaining the connection between the first party and the telephone switch.

A sixth aspect of the invention provides a method of managing telephone calls, the method comprising: receiving a first notification on an automatic voice response unit from a telephone switch that manages a telephone call connection between a first party and a second party; wherein the first notification informs the automatic voice response unit that the telephone call connection has been maintained between the switch and the second party while the connection between the switch and the first party has been dropped; and automatically, in response to the first notification, sending a second notification to the telephone switch to reconnect the call between the first party and the second party.

A seventh aspect of the invention provides a system comprising: a telephone switch including: a component configured to manage a connected call between a first party and a second party; a component configured to maintain the connected call from the telephone switch to the second party while dropping the connection between the first party and the telephone switch; and an automatic voice response unit including: a component configured to receive a first notification from the telephone switch; wherein the first notification informs the automatic voice response unit that the telephone call connection has been maintained between the switch and the second party while the connection between the switch and the first party has been dropped; and a component configured to automatically, in response to the first notification, send a second notification to the telephone switch to reconnect the call between the first party and the second party.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1A shows a simplified schematic of a prior art system for managing telephone calls.

FIG. 1B shows a simplified schematic of a system according to an embodiment of the present invention.

FIGS. 2A and 2B show another illustrative system according to two embodiments of the present invention.

FIG. 3 shows an illustrative process flow diagram according to an embodiment of the present invention.

FIG. 4 shows an illustrative computer infrastructure for managing telephone calls according to an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

Disclosed herein is a solution for managing telephone calls that allows a telephone switch to maintain a connection with one Party to a telephone call while allowing the connection between the switch and the other Party to be disconnected. When the parties wish to be reconnected, the switch re-establishes the connection between the switch and the other Party and reconnects the call.

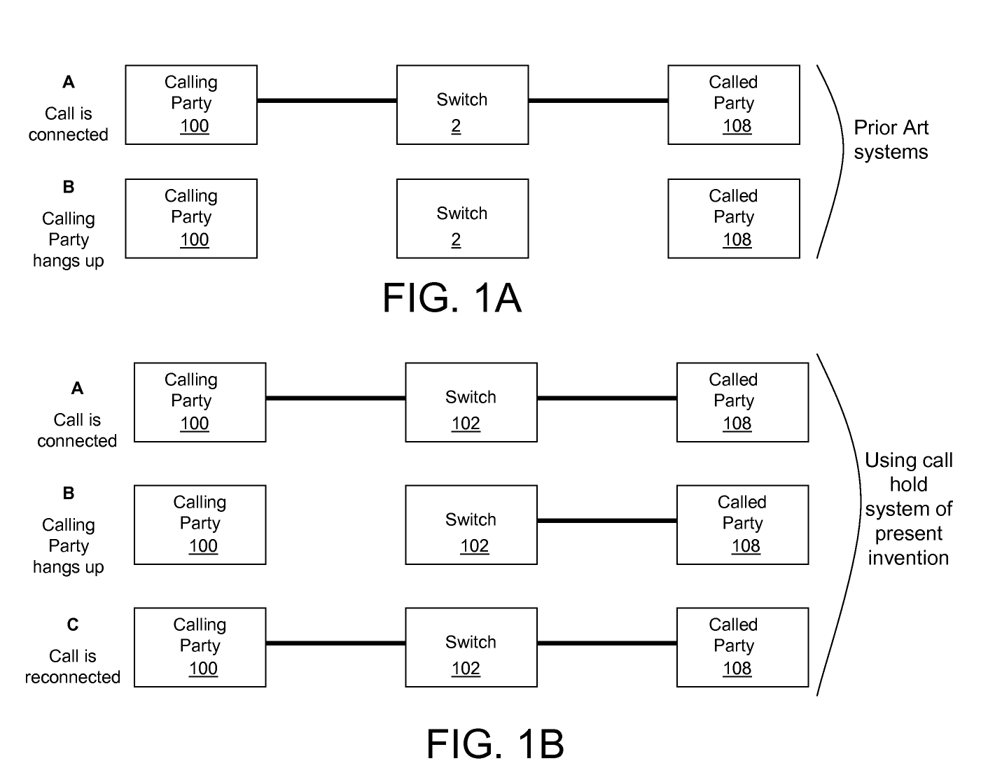

Turning to FIG. 1A, a simplified schematic is shown, illustrating a commonly understood method of managing a telephone call. As shown in FIG. 1A, in existing systems of managing a telephone call, a Calling Party 100 places a call through one or more switches 2 to a Called Party 108. (While only one switch is shown in FIG. 1, it should be noted that multiple switches 2 can also be provided between Calling Party 100 and Called Party 108). This connected call is indicated by situation A in FIG. 1A. If either Party 100, 108 hangs up or disconnects the call, the entire call is disconnected, and there are no maintained connections between the switch 2 and the Parties 100, 108. This is shown in situation B in FIG. 1A.

Turning to FIG. 1B, showing an embodiment of the invention disclosed herein, when Calling Party 100 places a call through switch 102 to Called Party 108 (situation A in FIG. 1B), the call can be placed in a “hold mode.” In this “hold mode”, either party 100, 108 (shown as Calling Party 100 in the example shown in FIG. 1B), can hang up or disconnect the call, as shown in situation B in FIG. 1B. However, in contrast to existing systems, switch 102 maintains the connection between switch 102 and the other party, e.g., Called Party 108 in the example shown in FIG. 1B. Subsequently, switch 102 reconnects the Parties as shown in situation C in FIG. 1B. A more detailed explanation of the aspects shown in FIG. 1B is provided below.

It is noted that embodiments of the inventions disclosed herein can be implemented inside a phone line termination device (i.e., telephone switch). As is known in the art, the telephone switch can listen for “dial tones,” which have characteristic patterns. As illustrated by the discussion herein, embodiments of the inventions disclosed here do not require the installation of special computer telephony integration (CTI), Local Exchange (PABX) or Automatic Call Distributor (ACD) at either party's end. In an illustrative application, a caller can avoid waiting in a call queue even when calling an organization that does not provide that service. As such, the present disclosure provides a feature that can be managed on switch 102 that terminates Calling Party's 100 phone services, and/or on the Called Party's 108 (e.g., a call center) phone services.

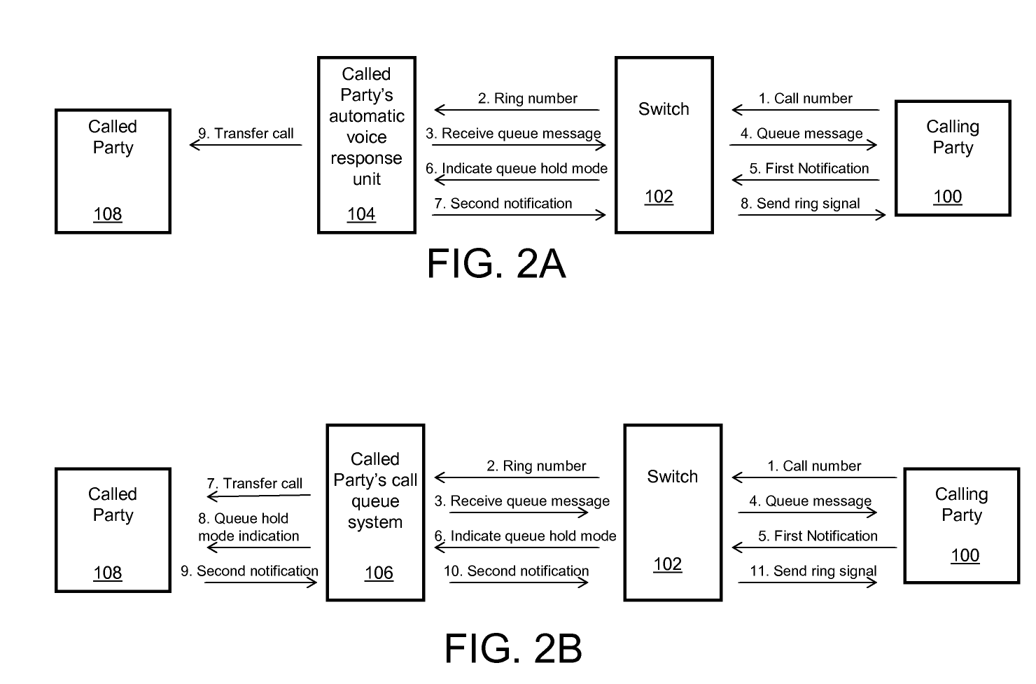

Turning to the drawings, FIGS. 2A and 2B show illustrative process flow diagrams according to embodiments of the inventions discussed herein.

FIG. 2A shows Calling Party 100 placing a call to Called Party 108, and switch 102 receiving the request to place the call (step 1). Switch 102 rings the requested number (step 2) and connects the call. Rather than continuing with the connected call, either party 100, 108 may opt to place the call on hold. For example, Called Party 108 may place the call in a queue awaiting an available operator.

In the embodiment of FIG. 2A, Called Party 108 has an automatic voice response unit 104 which receives the ring from switch 102. In this embodiment, automatic voice response unit 104 sends a message to switch 102 that the call has been placed in a queue (step 3). Switch 102 passes along this message to Calling Party 100 (step 4). In this embodiment, Calling Party 100 then sends a notification to switch 102 to place the call in “hold mode” (step 5). Switch 102 then places the call in “hold mode,” which is discussed in more detail herein. The notification to switch 102 can be achieved by any standard means, including, for example, keying in a code, or tone, or by responding orally to a question from the call center. Calling Party 100 may also choose to specify a wait time (e.g., in minutes). For example, Calling Party 100 may key in “#99*30” where the “#99” means go into “hold mode” and the “*30” means to notify Calling Party 100 if the call has not been “answered” by Called Party 108 within thirty (30) minutes. In addition, although FIG. 2A shows the notification being sent by Calling Party 100, the notification need not come from Calling Party 100, for example, it can be sent by Called Party 108, or automatically by Called Party's system 104.

After receiving this notification from Calling Party 100, switch 102 can indicate to Called Party 108 that the call has been placed in “hold mode” (step 6). This indication can be in the form of a looped message played to Called Party 108, or other known means of relaying the information to Called Party 108 and/or Called Party's automatic voice response unit 104. This message can also inform Called Party 108 that they can choose to reconnect to Calling Party 100 by sending a notification to switch 102.

While in “hold mode,” telephony switch 102 continues to maintain the connection between Called Party 108 and switch 102, whether or not Calling Party 100 hangs up the phone. In other words, from Calling Party's 100 perspective, at this point, the call is no longer connected. Calling Party 100 can hang up the telephone, and/or use the telephone for other purposes, if desired. However, switch 102 continues to maintain the connection between switch 102 and Called Party's 108 telephone system, regardless of whether Calling Party 100 has disconnected the call from their end.

There are now two possible actions that may occur, depending on whether Called Party 108 has a system that is “hold mode” aware or not. In a first embodiment, (shown in FIG. 2A), remote voice response system 104 automatically sends an appropriate signal to “wake” up a held call, and in another embodiment, (shown in FIG. 2B), Called Party 108 manually takes appropriate action required to “wake” up a held call. Both modes of operation are discussed in more detail herein.

As shown in FIG. 2A, if remote voice response unit 104 is “hold mode” aware, when the parties are ready to reconnect the call (in this example, when the call reaches the front of the queue), automatic voice response unit 104 automatically sends a notification to switch 102 (step 7) notifying switch 102 to reconnect the call. Again, this notification can be sent by traditional means, including sending a tone sequence. Automatic voice response unit 104 can either “listen to tones” and “send tones back” to switch 102, or this can be achieved via underlying integration between automatic voice unit 104 and switch 102 through switch 102's signaling protocols, such as session initiation protocol (SIP) (for Voice over IP applications) protocol extension. Telephone switch 102 is “listening” to the remote line and in response to hearing the notification (for example the tone sequence “#12345#”), switch 102 sends a reconnect signal (e.g., a ring signal) to Calling Party 100 (step 8). Automatic voice response unit 104 also automatically transfers the call to Called Party 108 (step 9). Calling Party 100 can answer the telephone or respond to the reconnect signal to be connected with Called Party 108. It is noted that step 9, where automatic voice response unit 104 transfers the call to Called Party 108, can also occur before automatic voice response unit 104 sends a notification to switch 102 (step 7) and switch 102 sends a reconnect signal (step 8).

If Calling Party 100 is not on the phone when the reconnect signal is sent, the phone will ring (or notify Calling Party 100 in an equivalent manner) and Calling Party 100 can pick up the phone. If Calling Party 100 is on another call when the reconnect signal is sent, Calling Party 100 can hear a “call waiting” tone and can indicate that they would like to answer (for example, by keying in a number response). If the call back ring is not answered, switch 102 will simply hang up the call.

Turning to FIG. 2B, an embodiment is shown where Called Party's 108 system is not “hold mode” aware. For this embodiment, steps 1 through 6 are the same as the embodiment discussed in connection with FIG. 2A. However, in the embodiment shown in FIG. 2B, when the parties are ready to reconnect the call, Called Party's call queue system 106 transfers the call to Called Party 108 (step 7). Switch 102 notifies Called Party 108 that the call has been placed in “hold mode” (step 8). For example, switch 102 can play the looped message to Called Party 108. Called Party 108 manually sends a notification to its call queue system 106 (step 9), which then passes the notification along to switch 102 notifying switch 102 to reconnect the call (step 10). Again, this notification can be sent by traditional means, including sending a specified sequence of numbers and/or characters, or sending a tone sequence. As discussed above in connection with FIG. 2A, the user's telephony switch 102 is “listening” to the remote line and upon hearing the notification (for example the tone sequence “#12345#”), switch 102 will send a reconnect signal to Calling Party 100 (step 11). Calling Party 100 can then answer the telephone in response to the reconnect signal to be reconnected with Called Party 108.

For either embodiment discussed above, if a wait time had been specified in the first notification to switch 102 (step 5 in both FIGS. 2A and 2B), and the wake up notification (step 8 in FIG. 2A and step 10 in FIG. 2B) has not come through after the defined number of minutes (or a default wait time), telephone switch 102 can automatically send a reconnect signal to Calling Party's 100 phone and reconnect Calling Party 100 to Called Party 108. If Called Party 108 is still busy, or a call queue message is still playing, Calling Party 100 can either choose to hang up and disconnect completely, or go back into another “hold mode” waiting pattern.

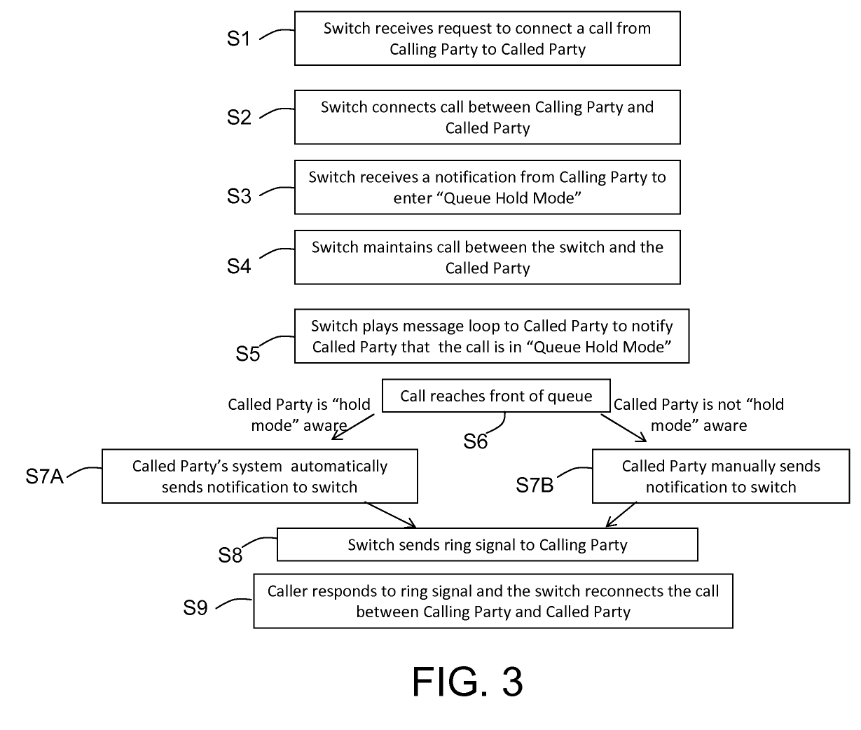

Turning to FIG. 3, an illustrative flow chart is shown according to an embodiment of the present invention. In step S1, a switch receives a request to connect a call from a Calling Party to a Called Party. In step S2, the switch connects the call. In step S3, the switch receives a notification from the Calling Party to place the call in “hold mode.” As discussed herein, this notification does not necessarily need to come from the Calling Party. However, in response to the notification, the switch will place the call in “hold mode.” The Calling Party can now hang up or disconnect the call, and use the telephone for other purposes. Meanwhile, while the call is in “hold mode” the switch continues to maintain the connection between the Called Party and the switch, as shown in step S4. In step S5, the switch can play a looped message to the Called Party to inform the Called Party that the call has been placed in “hold mode” and indicating what the Called Party can do to reconnect the call.

In step S6, the call has reached the front of the call queue (or for other reasons the parties have decided to reconnect the call). How the switch is notified to reconnect the call depends on whether the Called Party has an automatic voice response unit that is “hold mode” aware or not. If the Called Party has such a system, in step S7A, the automatic voice response unit can automatically notify the switch to reconnect the call. If the Called Party does not have such a system, in step S7B, the Called Party can manually notify the switch to reconnect the call, for example, by keying in a code. Either way, in step S8, the switch sends a reconnect signal to the Calling Party's phone. In step S9, the Calling Party responds to the reconnect signal (for example, by answering a ringing phone, or answering a call waiting tone), and the switch reconnects the call between the Calling Party and the Called Party.

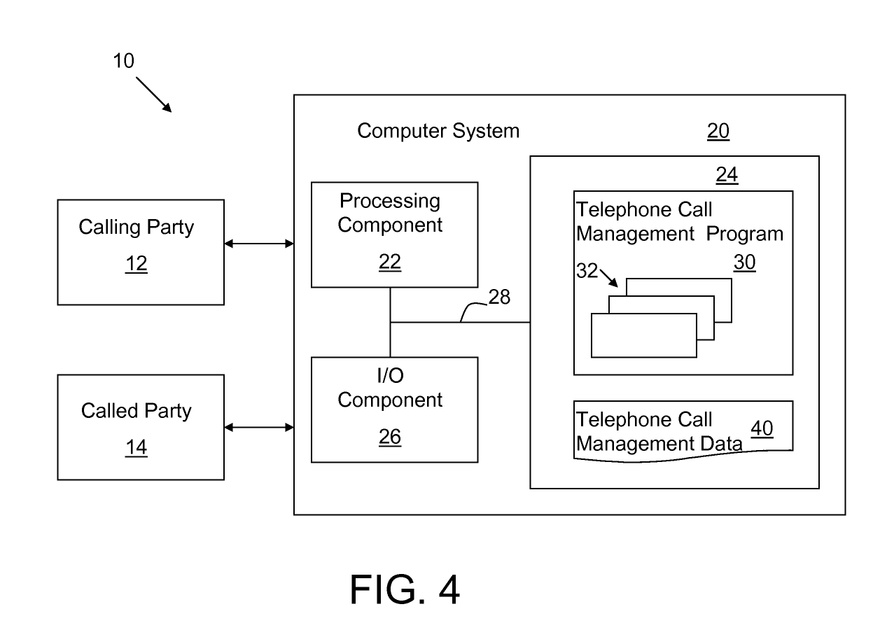

Turning to FIG. 4 an illustrative environment 10 is shown for managing telephone calls according to an embodiment. To this extent, environment 10 includes a computer system 20 that can perform a process described herein in order to manage telephone calls. In particular, computer system 20 is shown including a telephone call management program 30, which makes computer system 20 operable to manage telephone calls between a Calling Party 12 and a Called Party 14 by performing a process described herein. Consequently, computer system 20 can comprise an illustrative embodiment of telephone switch 102.

Computer system 20 is shown including a processing component 22 (e.g., one or more processors), a storage component 24 (e.g., a storage hierarchy), an input/output (I/O) component 26 (e.g., one or more I/O interfaces and/or devices), and a communications pathway 28. In general, processing component 22 executes program code, such as telephone management program 30, which is at least partially fixed in storage component 24. While executing program code, processing component 22 can process data, which can result in reading and/or writing transformed data from/to storage component 24 and/or I/O component 26 for further processing. Pathway 28 provides a communications link between each of the components in computer system 20. I/O component 26 can comprise one or more human I/O devices, which enable a human user to interact with computer system 20 and/or one or more communications devices to enable a system user to communicate with computer system 20 using any type of communications link. To this extent, telephone call management program 30 can manage a set of interfaces (e.g., graphical user interface(s), application program interface, and/or the like) that enable human and/or system users to interact with telephone call management program 30. Further, telephone call management program 30 can manage (e.g., store, retrieve, create, manipulate, organize, present, etc.) the data, such as telephone call management data 40, using any solution. Telephone call management data 40 can include data related to managing telephone calls such as telephone numbers, routing switches, etc.

In any event, computer system 20 can comprise one or more general purpose computing articles of manufacture (e.g., computing devices) capable of executing program code, such as telephone call management program 30, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, telephone call management program 30 can be embodied as any combination of system software and/or application software.

Further, telephone call management program 30 can be implemented using a set of modules 32. In this case, a module 32 can enable computer system 20 to perform a set of tasks used by telephone call management program 30, and can be separately developed and/or implemented apart from other portions of telephone call management program 30. As used herein, the term “component” means any configuration of hardware, with or without software, which implements the functionality described in conjunction therewith using any solution, while the term “module” means program code that enables a computer system 20 to implement the functionality described in conjunction therewith using any solution. When fixed in a storage component 24 of a computer system 20 that includes a processing component 22, a module is part of a component. Regardless, it is understood that two or more components, modules, and/or systems may share some/all of their respective hardware and/or software. Further, it is understood that some of the functionality discussed herein may not be implemented or additional functionality may be included as part of computer system 20.

When computer system 20 comprises multiple computing devices, each computing device can have only a portion of telephone call management program 30 fixed thereon (e.g., one or more modules 32). However, it is understood that computer system 20 and telephone call management program 30 are only representative of various possible equivalent computer systems that may perform a process described herein. To this extent, in other embodiments, the functionality provided by computer system 20 and telephone call management program 30 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 20 includes multiple computing devices, the computing devices can communicate over any type of communications link. Further, while performing a process described herein, computer system 20 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

While shown and described herein as a method and system for telephone call management, it is understood that aspects of the invention further provide various alternative embodiments. For example, in one embodiment, the invention provides a computer program fixed in at least one computer-readable medium, which when executed, enables a computer system to telephone call management. To this extent, the computer-readable medium includes program code, such as telephone call management program 30 (FIG. 4), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; and/or the like.

In another embodiment, the invention provides a method of providing a copy of program code, such as telephone call management program 30 (FIG. 4), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for telephone call management. In this case, a computer system, such as computer system 20 (FIG. 4), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

As indicated above, aspects of the invention provide a solution for managing telephone calls. As used herein, unless otherwise noted, the term “set” means one or more (i.e., at least one) and the phrase “any solution” means any now known or later developed solution.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method of managing telephone calls, the method comprising:
receiving a first notification on a telephone switch from a first party on a first connected call between only the first party and a second party; and
maintaining the first connected call from the telephone switch to the second party in response to receiving the first notification, without regard for the first party maintaining the connection between the first party and the telephone switch.

2. The method of claim 1, further comprising:
receiving a second notification from the second party at the telephone switch; and
sending a reconnect signal from the telephone switch to the first party in response to receiving the second notification from the second party.

3. The method of claim 2, further comprising reconnecting the call between the first party and second party after sending the reconnect signal.

4. The method of claim 1, further comprising sending a reconnect signal to the first party after a specified period of time after receiving the first notification.

5. The method of claim 4, further comprising reconnecting the call between the first party and the second party after sending the reconnect signal.

6. The method of claim 1, further comprising prompting the second party to send a second notification to be reconnected with the first party.

7. The method of claim 1, further comprising receiving a request from the first party to connect a second call to a third party while maintaining the first connected call.

8. A system for managing telephone calls, the system comprising:
a telephone switch including:
a component configured to receive a first notification from a first party on a first connected call between only the first party and a second party; and
a component configured to maintain the first connected call from the telephone switch to the second party in response to receiving the first notification, without regard for the first party maintaining the connection between the first party and the telephone switch.

9. The system of claim 8, the telephone switch further including:
a component configured to receive a second notification from the second party; and
a component configured to send a reconnect signal to the first party in response to receiving the second notification from the second party.

10. The system of claim 9, the telephone switch further including a component configured to reconnect the call between the first party and second party after sending the reconnect signal.

11. The system of claim 8, the telephone switch further including a component configured to send a reconnect signal to the first party after a specified period of time after receiving the first notification.

12. The system of claim 11, the telephone switch further including a component configured to reconnect the call between the first party and the second party after sending the reconnect signal.

13. The system of claim 8, the telephone switch further including a component configured to prompt the second party to send a second notification to be reconnected with the first party.

14. A program product stored on a computer-readable medium, which when executed, enables a telephone switch to implement a method for managing telephone calls, the program product comprising:
program code for receiving a first notification from a first party on a first connected call between only the first party and a second party; and
program code for maintaining the first connected call between the telephone switch to the second party in response to receiving the first notification, without regard for the first party maintaining the connection between the first party and the telephone switch.

15. The program product of claim 14, further comprising:
program code for receiving a second notification from the second party; and
program code for sending a reconnect signal to the first party in response to receiving the second notification from the second party.

16. The program product of claim 15, further comprising program code for reconnecting the call between the first party and second party after sending the reconnect signal.

17. The program product of claim 14, further comprising program code for sending a reconnect signal to the first party after a specified period of time after receiving the first notification.

18. The program product of claim 17, further comprising program code for reconnecting the call between the first party and the second party after sending the reconnect signal.

19. The program product of claim 14, further comprising program code for prompting the second party to send a second notification to be reconnected with the first party.

20. A method of generating a system for managing telephone calls, the method comprising:
providing a telephone switch operable to:
receive a first notification from a first party on a first connected call between only the first party and a second party; and
maintain the first connected call from the telephone switch to the second party in response to receiving the first notification, without regard for the first party maintaining the connection between the first party and the telephone switch.
